(19) United States
(12) Patent Application Publication
(10) Pub. No.: US 2026/0313151 A1
(43) Pub. Date: Oct. 8, 2026

(54) METHOD AND APPARATUS FOR VIDEO CODING

(71) Applicant: MEDIATEK INC., Hsinchu City (TW)

(72) Inventors: Yi-Wen CHEN, San Jose, CA (US); Olena CHUBACH, San Jose, CA (US); Ching-Yeh CHEN, Hsinchu City (TW)

(21) Appl. No.: 19/108,231

(22) PCT Filed: Sep. 6, 2023
(86) PCT No.: PCT/CN2023/117166

§ 371 Date: Mar. 3, 2025

Related U.S. Application Data
(60) Provisional application No. 63/374,607, filed on Sep. 6, 2022.

(51) Int. Cl. H04N 19/513; H04N 19/139; H04N 19/176

(52) U.S. Cl. CPC H04N 19/513; H04N 19/139; H04N 19/176

(57) ABSTRACT

Aspects of the disclosure provide methods, apparatuses, and a non-transitory computer-readable storage medium for video coding. An apparatus includes processing circuitry that decodes prediction information of a current block in a current picture of a video sequence. The prediction information indicates a bilateral matching advanced motion vector prediction (AMVP)-merge mode for the current block. The processing circuitry determines an AMVP predictor and a merge predictor for the current block, performs a motion vector (MV) refinement on one of unrefined MVs of the AMVP predictor and the merge predictor to obtain a refined MV for one of the AMVP predictor and the merge predictor, and decodes the current block based on the refined MV selected for the one of the AMVP predictor and the merge predictor and one of the unrefined MVs selected for the other of the AMVP predictor and the merge predictor.

### INCORPORATION BY REFERENCE

This present disclosure claims the benefit of priority to U.S. Provisional Application No. 63/374,607, “INTER PREDICTION FOR VIDEO CODING” filed on Sep. 6, 2022, which is incorporated by reference herein in its entirety.

### TECHNICAL FIELD

The present disclosure describes embodiments generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

One purpose of video coding (e.g., encoding and/or decoding) can be a reduction of redundancy in an input video signal, through a compression. The compression can help reduce bandwidth or storage space requirements. Both lossless and lossy compression, as well as a combination thereof can be employed.

Video coding can be performed using an inter-picture prediction with motion compensation. Motion compensation can be a lossy compression technique and can relate to techniques where a block of sample data from a previously reconstructed picture or part thereof (reference picture), after being spatially shifted in a direction indicated by a motion vector (MV henceforth), is used for the prediction of a newly reconstructed picture or picture part.

### SUMMARY

Aspects of the disclosure provide a method for video coding. The method includes decoding prediction information of a current block in a current picture of a video sequence. The prediction information indicates a bilateral matching advanced motion vector prediction (AMVP)-merge mode for the current block. The method includes determining an AMVP predictor and a merge predictor for the current block. The method includes performing a first motion vector (MV) refinement on one of unrefined MVs of the AMVP predictor and the merge predictor to obtain a first refined MV for one of the AMVP predictor and the merge predictor. The method includes decoding the current block based on the first refined MV selected for the one of the AMVP predictor and the merge predictor and one of the unrefined MVs selected for the other of the AMVP predictor and the merge predictor.

In an embodiment, the method includes performing a second MV refinement on the other of the AMVP predictor and the merge predictor to obtain a second refined MV for the other of the AMVP predictor and the merge predictor.

In an embodiment, the first MV refinement is one of bilateral matching refinement and template matching refinement.

In an embodiment, the prediction information indicates a MV difference (MVD), and the performing includes performing the first MV refinement on the one of the unrefined MVs of the AMVP predictor and the merge predictor based on a value of the MVD.

In an embodiment, the performing includes performing the first MV refinement on the unrefined MV of the AMVP predictor in response to the value of the MVD not being zero; and performing the first MV refinement on the unrefined MV of the merge predictor in response to the value of the MVD being zero.

In an embodiment, the merge mode used in the bilateral matching AMVP-merge mode is one of affine merge, combined inter-intra prediction (CIIP), merge mode with motion vector difference (MMVD), intra block copy (IBC) merge, and geometric partition mode (GPM).

In an embodiment, the AMVP mode used in the bilateral matching AMVP-merge mode is one of affine mode and IBC mode.

Aspects of the disclosure provide an apparatus for video coding. The apparatus includes processing circuitry that decodes prediction information of a current block in a current picture of a video sequence. The prediction information indicates a bilateral matching AMVP-merge mode for the current block. The processing circuitry determines an AMVP predictor and a merge predictor for the current block, performs an MV refinement on one of unrefined MVs of the AMVP predictor and the merge predictor to obtain a refined MV for one of the AMVP predictor and the merge predictor, and decodes the current block based on the refined MV selected for the one of the AMVP predictor and the merge predictor and one of the unrefined MVs selected for the other of the AMVP predictor and the merge predictor.

Aspects of the disclosure provide a method of video coding at an encoder. The method includes generating prediction information of a current block in a current picture of a video sequence, the prediction information indicating a bilateral matching AMVP-merge mode for the current block. The method includes determining an AMVP predictor and a merge predictor for the current block. The method includes performing a first MV refinement on one of unrefined MVs of the AMVP predictor and the merge predictor to obtain a first refined MV for one of the AMVP predictor and the merge predictor. The method includes encoding the current block based on the first refined MV selected for the one of the AMVP predictor and the merge predictor and one of the unrefined MVs selected for the other of the AMVP predictor and the merge predictor.

Aspects of the disclosure also provide a non-transitory computer-readable medium storing instructions which when executed by a computer for video decoding cause the computer to perform the method for video decoding.

### BRIEF DESCRIPTION OF THE DRAWINGS

Further features, the nature, and various advantages of the disclosed subject matter will be more apparent from the following detailed description and the accompanying drawings in which:

FIG. 1 shows a block diagram of an encoder according to embodiments of the disclosure;

FIG. 2 shows a block diagram of a decoder according to embodiments of the disclosure;

FIG. 3 is a schematic illustration of a computer system according to embodiments of the disclosure;

FIG. 4 shows four splitting types in a multi-type tree structure according to embodiments of the disclosure;

FIG. 5 shows a CTU divided into multiple CUs using a quadtree with nested multi-type tree partition according to embodiments of the disclosure;

FIG. 6 shows MMVD search points of two references according to embodiments of the disclosure;

FIG. 7 shows exemplary 4-parameter and 6-parameter affine models and according to embodiments of the disclosure;

FIG. 8 shows an exemplary affine motion compensation for a 16×16 luma block 801 according to embodiments of the disclosure;

FIG. 9 shows candidate blocks of the inherited affine candidates according to embodiments of the disclosure;

FIG. 10 shows an exemplary control point motion vector inheritance according to embodiments of the disclosure;

FIG. 11 shows example candidate positions for constructed affine merge mode according to embodiments of the disclosure;

FIG. 12 shows an exemplary decoding side motion vector refinement according to embodiments of the disclosure;

FIG. 13 shows examples of the GPM splits grouped by identical angles according to embodiments of the disclosure;

FIG. 14 shows top and left neighboring blocks used in CIIP weight derivation according to embodiments of the disclosure;

FIG. 15 shows examples of template matching according to embodiments of the disclosure;

FIG. 16 shows exemplary diamond shape search regions according to embodiments of the disclosure;

FIG. 17 shows an exemplary bilateral matching AMVP-merge mode according to embodiments of the disclosure;

FIG. 18 shows a flowchart illustrating a process of decoding a current block according to embodiments of the disclosure; and

FIG. 19 shows a flowchart illustrating a process of encoding a current block according to embodiments of the disclosure.

### DETAILED DESCRIPTION OF EMBODIMENTS

### I. Video Encoder

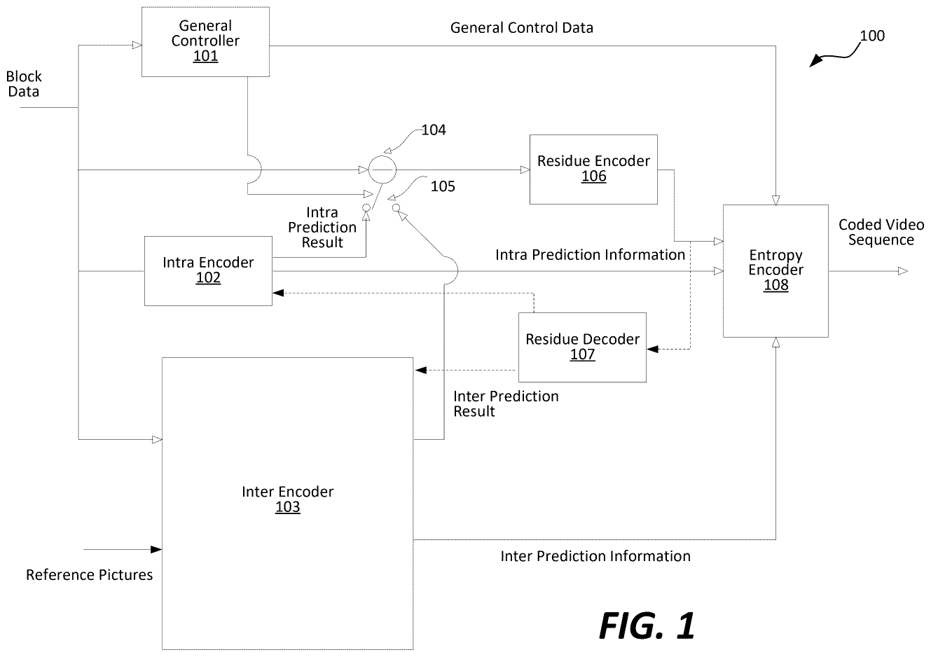

FIG. 1 shows a diagram of a video encoder 100 according to embodiments of the disclosure. The video encoder 100 is configured to receive a processing block (e.g., a prediction block) of sample values within a current video picture in a sequence of video pictures and encode the processing block into an encoded picture that is part of an encoded video sequence.

In an example, the video encoder 100 receives a matrix of sample values for a processing block, such as a prediction block of 8×8 samples, and the like. The video encoder 100 determines whether the processing block is best encoded using intra mode, inter mode, or bi-prediction mode using, for example, rate-distortion optimization. When the processing block is to be encoded in intra mode, the video encoder 100 may use an intra prediction technique to encode the processing block into the encoded picture; and when the processing block is to be encoded in inter mode or bi-prediction mode, the video encoder 100 may use an inter uni-prediction or bi-prediction technique, respectively, to encode the processing block into the encoded picture. In certain video coding technologies, merge mode can be an inter picture prediction sub-mode where the motion vector is derived from one or more motion vector predictors without the benefit of a coded motion vector component outside the predictors. In certain other video coding technologies, a motion vector component applicable to the subject block may be present. In an example, the video encoder 100 includes other components, such as a mode decision module (not shown) to determine the mode of the processing blocks.

In FIG. 1, the video encoder 100 can include a general controller 101, an intra encoder 102, an inter encoder 103, a residue calculator 104, a switch 105, a residue encoder 106, a residue decoder 107, and an entropy encoder 108.

The general controller 101 is configured to determine general control data and control other components of the video encoder 100 based on the general control data. In an example, the general controller 101 determines the mode of the block and provides a control signal to the switch 105 based on the mode. For example, when the mode is the intra mode, the general controller 101 controls the switch 105 to select the intra mode result for use by the residue calculator 104, and controls the entropy encoder 108 to select the intra prediction information and include the intra prediction information in the bitstream; and when the mode is the inter mode, the general controller 101 controls the switch 105 to select the inter prediction result for use by the residue calculator 104, and controls the entropy encoder 108 to select the inter prediction information and include the inter prediction information in the bitstream.

The intra encoder 102 is configured to receive the samples of the current block (e.g., a processing block), in some cases compare the block to blocks already encoded in the same picture, generate quantized coefficients after transform, and in some cases also intra prediction information (e.g., an intra prediction direction information according to one or more intra encoding techniques). In an example, the intra encoder 102 also calculates intra prediction results (e.g., predicted block) based on the intra prediction information and reference blocks in the same picture.

The inter encoder 103 is configured to receive the samples of the current block (e.g., a processing block), compare the block to one or more reference blocks in reference pictures (e.g., blocks in previous pictures and later pictures), generate inter prediction information (e.g., description of redundant information according to inter encoding technique, motion vectors, merge mode information), and calculate inter prediction results (e.g., predicted block) based on the inter prediction information using any suitable technique. In some examples, the reference pictures are decoded reference pictures that are decoded based on the encoded video information.

The residue calculator 104 is configured to calculate a difference (residue data) between the received block and prediction results selected from the intra encoder 102 or the inter encoder 103. The residue encoder 106 is configured to operate based on the residue data to encode the residue data to generate the transform coefficients. In an example, the residue encoder 106 is configured to convert the residue data from a spatial domain to a frequency domain and generate the transform coefficients. The transform coefficients are then subject to quantization processing to obtain quantized transform coefficients. In various embodiments, the video encoder 100 also includes a residue decoder 107. The residue decoder 107 is configured to perform inverse-transform and generate the decoded residue data. The decoded residue data can be suitably used by the intra encoder 102 and the inter encoder 103. For example, the inter encoder 103 can generate decoded blocks based on the decoded residue data and inter prediction information, and the intra encoder 102 can generate decoded blocks based on the decoded residue data and the intra prediction information. The decoded blocks are suitably processed to generate decoded pictures and the decoded pictures can be buffered in a memory circuit (not shown) and used as reference pictures in some examples.

The entropy encoder 108 is configured to format the bitstream to include the encoded block. The entropy encoder 108 is configured to include various information according to a suitable standard, such as the HEVC standard, VVC or any other video coding standard. In an example, the entropy encoder 108 is configured to include the general control data, the selected prediction information (e.g., intra prediction information or inter prediction information), the residue information, and other suitable information in the bitstream. Note that, according to the disclosed subject matter, when coding a block in the merge sub-mode of either inter mode or bi-prediction mode, there is no residue information.

### II. Video Decoder

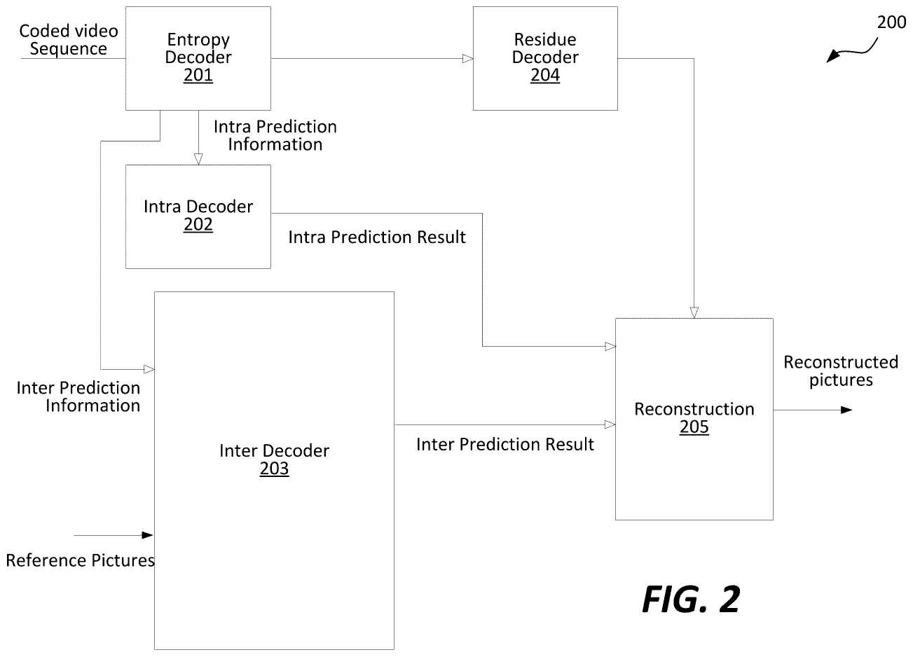

FIG. 2 shows a diagram of a video decoder 200 according to embodiments of the disclosure. The video decoder 200 is configured to receive to-be-decoded pictures that are part of a to-be-decoded video sequence and decode the to-be-decoded pictures to generate reconstructed pictures.

In FIG. 2, the video decoder 200 can include an entropy decoder 201, an intra decoder 202, an inter decoder 203, a residue decoder 204, a reconstruction module 205.

The entropy decoder 201 can be configured to reconstruct, from the encoded picture, certain symbols that represent the syntax elements of which the encoded picture is made up. Such symbols can include, for example, the mode in which a block is encoded (such as, for example, intra mode, inter uni-directional prediction mode, inter bi-predicted mode, the latter two in merge sub-mode or another sub-mode), prediction information (such as, for example, intra prediction information or inter prediction information) that can identify certain sample or metadata that is used for prediction by the intra decoder 202 or the inter decoder 203, respectively, residual information in the form of, for example, quantized transform coefficients, and the like. In an example, when the prediction mode is inter or bi-predicted mode, the inter prediction information is provided to the inter decoder 203; and when the prediction type is the intra prediction type, the intra prediction information is provided to the intra decoder 202. The residual information can be subject to inverse quantization and is provided to the residue decoder 204.

The intra decoder 202 is configured to receive the intra prediction information and generate prediction results based on the intra prediction information.

The inter decoder 203 is configured to receive the inter prediction information and generate inter prediction results based on the inter prediction information.

The residue decoder 204 is configured to perform inverse quantization to extract de-quantized transform coefficients and process the de-quantized transform coefficients to convert the residual from the frequency domain to the spatial domain. The residue decoder 204 may also require certain control information (to include the Quantizer Parameter (QP)), and that information may be provided by the entropy decoder 201 (data path not depicted as this may be low volume control information only).

The reconstruction module 205 is configured to combine, in the spatial domain, the residual as output by the residue decoder 204 and the prediction results (as output by the inter or intra prediction modules as the case may be) to form a reconstructed block, that may be part of the reconstructed picture, which in turn may be part of the reconstructed video. It is noted that other suitable operations, such as a deblocking operation and the like, can be performed to improve the visual quality.

### III. Computer System

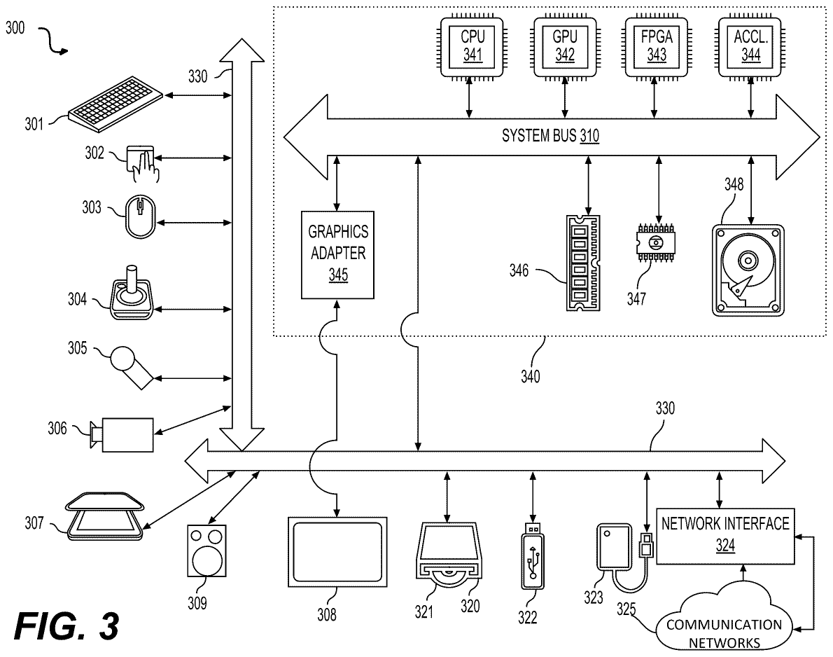

FIG. 3 shows a computer system 300 suitable for implementing embodiments of the disclosed subject matter. The techniques described in this disclosure, can be implemented as computer software using computer-readable instructions and physically stored in one or more computer-readable media. The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 3 for the computer system 300 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of the computer system 300.

The computer system 300 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 301, trackpad 302, mouse 303, joystick 304, microphone 305, camera 306, scanner 307, and touch screen 308.

The computer system 300 may also include certain human interface output devices. Such human interface output devices may be stimulating the senses of one or more human users through, for example, tactile output, sound, light, and smell/taste. Such human interface output devices may include tactile output devices (e.g., tactile feedback by the touch-screen 308 or joystick 304, but there can also be tactile feedback devices that do not serve as input devices), audio output devices (e.g., speaker 309), visual output devices (e.g., screens 308 to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted). These visual output devices (such as screens 308) can be connected to a system bus 310 through a graphics adapter 850.

The computer system 300 can also include human accessible storage devices and their associated media such as optical media including CD/DVD ROM/RW 320 with CD/DVD or the like media 321, thumb-drive 322, removable hard drive or solid state drive 323, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

The computer system 300 can also include a network interface 324 to one or more communication networks 325. The one or more communication networks 325 can for example be wireless, wireline, optical. The one or more communication networks 325 can further be local, wide-area, metropolitan, vehicular and industrial, real-time, delay-tolerant, and so on. Examples of the one or more communication networks 325 include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses 330 (such as, for example USB ports of the computer system 300; others are commonly integrated into the core of the computer system 300 by attachment to a system bus as described below (for example Ethernet interface into a PC computer system or cellular network interface into a smartphone computer system). Using any of these networks, the computer system 300 can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core 340 of the computer system 300.

The core 340 can include one or more CPUs 341, one or more GPUs 342, one or more specialized programmable processing units in the form of Field Programmable Gate Areas (FPGA) 343, hardware accelerators for certain tasks 344, graphics adapters 345, and so forth. These devices, along with Random-access memory 346, Read-only memory (ROM) 347, internal mass storage 348 such as internal non-user accessible hard drives, SSDs, and the like, may be connected through the system bus 310. In some computer systems, the system bus 310 can be accessible in the form of one or more physical plugs to enable extensions by additional CPUs, GPU, and the like. The peripheral devices can be attached either directly to the system bus 310, or through a peripheral bus 330. In an example, the screen 308 can be connected to the graphics adapter 345. Architectures for a peripheral bus include PCI, USB, and the like.

CPUs 341, GPUs 342, FPGAs 343, and accelerators 344 can execute certain instructions that, in combination, can make up the aforementioned computer code. That computer code can be stored in ROM 347 or RAM 346. Transitional data can also be stored in RAM 346, whereas permanent data can be stored for example, in the internal mass storage 348. Fast storage and retrieve to any of the memory devices can be enabled through the use of cache memory, that can be closely associated with one or more CPU 341, GPU 342, mass storage 348, ROM 347, RAM 346, and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture 300 and specifically the core 340 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 340 that are of non-transitory nature, such as core-internal mass storage 348 or ROM 347. The software implementing various embodiments of the present disclosure can be stored in such devices and executed by core 340. A computer-readable medium can include one or more memory devices or chips, according to particular needs. The software can cause the core 340 and specifically the processors therein (including CPU, GPU, FPGA, and the like) to execute particular processes or particular parts of particular processes described herein, including defining data structures stored in RAM 346 and modifying such data structures according to the processes defined by the software. In addition or as an alternative, the computer system can provide functionality as a result of logic hardwired or otherwise embodied in a circuit (for example: accelerator 344), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

### IV. Coding Tree Unit Partitioning

In High-Efficient Video Coding standard (HEVC), a picture can be divided into a sequence of coding tree units (CTUs). A CTU can include an N×N block of luma samples together with two corresponding blocks of chroma samples for a picture that has three sample arrays, or an N×N block of samples of a monochrome plane in a picture that is coded using three separate color planes. The CTU concept is broadly analogous to that of a macroblock in previous standards such as Advanced Video Coding (AVC). A maximum allowed size of a luma block in a CTU can be specified to be 64×64 in Main profile. A CTU can be split into coding units (CUs) by using a quaternary-tree structure denoted as coding tree to adapt to various local characteristics. A decision whether to code a picture area using inter-picture (temporal) or intra-picture (spatial) prediction can be made at a leaf CU level. Each leaf CU can be further split into one, two, or four prediction units (PUs) according to a PU splitting type. Inside one PU, a same prediction process can be applied, and relevant information can be transmitted to a decoder on a PU basis. After obtaining a residual block by applying a prediction process based on the PU splitting type, a leaf CU can be partitioned into transform units (TUs) according to another quaternary-tree structure similar to the coding tree for the CU. One key feature of the HEVC structure is that it has the multiple partition conceptions including CU, PU, and TU.

Versatile Video Coding standard (VVC) is a successor to HEVC. In VVC, a quadtree with a nested multi-type tree using binary and ternary splits segmentation structure replaces the concepts of multiple partition unit types. That is, the separation of the CU, PU, and TU concepts is removed except as needed for a CU that has a size too large for a maximum transform length. In addition, more flexibility for CU partition shapes can be supported. In a coding tree structure, a CU can have either a square or rectangular shape. A coding tree unit (CTU) is first partitioned by a quaternary tree (or a quadtree) structure. Then, the quaternary tree leaf nodes can be further partitioned by a multi-type tree structure.

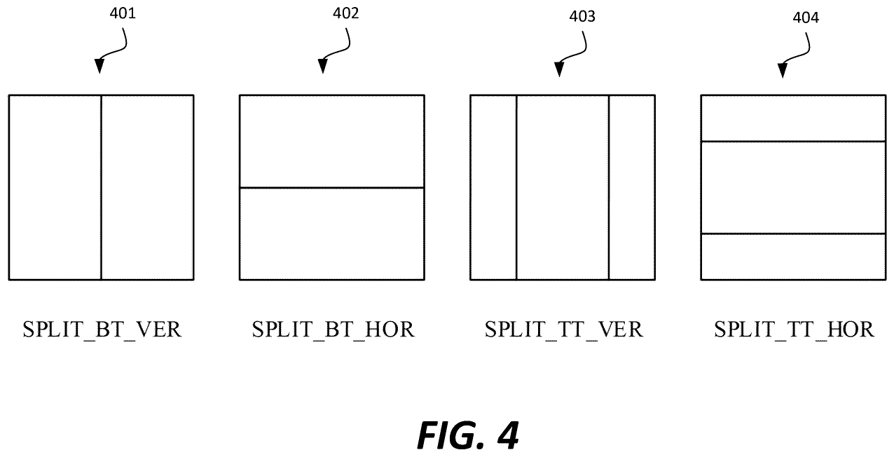

FIG. 4 shows four splitting types in a multi-type tree structure according to embodiments of the disclosure. The four splitting types include vertical binary splitting 401 (SPLIT_BT_VER), horizontal binary splitting 402 (SPLIT_BT_HOR), vertical ternary splitting 403 (SPLIT_TT_VER), and horizontal ternary splitting 404 (SPLIT_TT_HOR). The multi-type tree leaf nodes are referred to as CUs. Unless a CU is too large for the maximum transform length, this segmentation is used for prediction and transform processing without any further partitioning. This means that, in most cases, the CU, PU and TU can have the same block size in the quadtree with nested multi-type tree coding block structure. The exception occurs when the maximum supported transform length is smaller than a width or height of a color component of a CU.

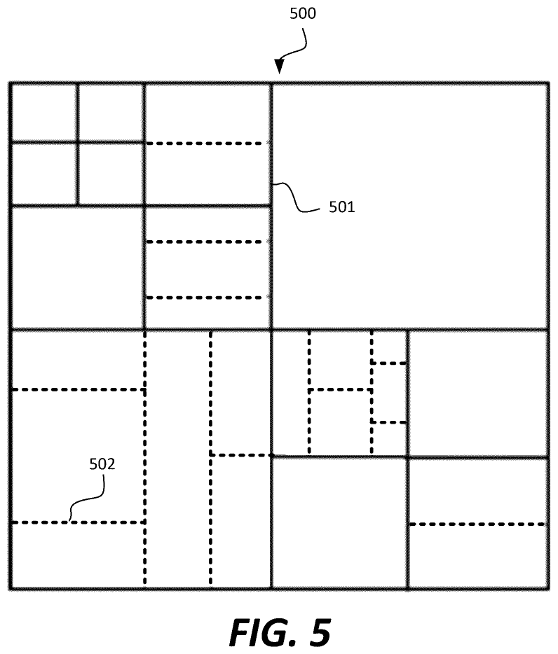

FIG. 5 shows a CTU 500 divided into multiple CUs using a quadtree with nested multi-type tree partition according to embodiments of the disclosure. In the CTU 500, a solid block edge (e.g., block edge 501) represents a quadtree partitioning and a dashed block edge (e.g., block edge 502) represents a multi-type tree partitioning. The quadtree with nested multi-type tree partition can provide a content-adaptive coding tree structure comprised of the multiple CUs. A size of a CU can be as large as the CTU 500 or as small as 4×4 in units of luma samples. For the case of the 4:2:0 chroma format, the maximum chroma coding block (CB) size is 64×64 and the minimum chroma CB can include 16 chroma samples.

In VVC, the maximum supported luma transform size is 64×64 and the maximum supported chroma transform size is 32×32. When a width or height of a CB is larger the maximum transform width or height, the CB can be automatically split along a horizontal and/or vertical direction to meet the transform size restriction in the corresponding direction.

In VVC, the coding tree scheme can support the ability for the luma and chroma to have separate block tree structures. For P and B slices, the luma and chroma CTBs in one CTU have to share the same coding tree structure. However, for I slices, the luma and chroma can have separate block tree structures. When separate block tree modes are applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three color components unless the video is monochrome.

For each inter-predicted CU, motion parameters can include motion vectors, reference picture indices, reference picture list usage index, and additional information needed for the new coding feature of VVC to be used for inter-predicted sample generation. The motion parameter can be signaled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighboring CUs, including spatial and temporal candidates, and additional schedules introduced in VVC. The merge mode can be applied to any inter-predicted CU, not only for skip mode. An alternative to merge mode is the explicit transmission of motion parameters, where motion vector, corresponding reference picture index for each reference picture list, reference picture list usage flag, and other needed information are signaled explicitly per each CU.

ITU-T VCEG (Q6/16) and ISO/IEC MPEG (JTC 1/SC 29/WG 5) are studying the potential need for standardization of future video coding technology with a compression capability that significantly exceeds that of the current VVC standard. The Enhanced Compression Model (ECM) reference software is provided to demonstrate a reference implementation of encoding techniques and the decoding process for JVET Enhanced compression beyond VVC capability exploration work. The reference software can be accessed via https://vcgit.hhi.fraunhofer.de/ecm/ECM.git. As a successor to VVC, ECM can share many common parts as VVC.

### V. Inter Prediction

In HEVC, for each inter PU, one of three prediction modes including inter, skip, and merge, can be selected. In an embodiment, a motion vector competition (MVC) scheme is introduced to select a motion candidate from a given candidate set that includes spatial and temporal motion candidates. Multiple references to the motion estimation allows finding the best reference in two possible reconstructed reference picture lists (namely List 0 and List 1). For the inter mode (e.g., advanced motion vector prediction (AMVP) mode), inter prediction indicators (List 0, List 1, or bi-directional prediction), reference indices, motion candidate indices, motion vector differences (MVDs), and prediction residual can be transmitted. For the skip mode and the merge mode, only merge indices are transmitted, and the current PU inherits the inter prediction indicator, reference indices, and motion vectors from a neighboring PU referred by the coded merge index. In the case of a skip coded CU, the residual signal is also omitted.

In VVC, AMVP mode is further improved by modes such as symmetric motion vector difference (SMVD) mode, adaptive motion vector resolution (AMVR), and affine AMVP mode. Merge/Skip modes are further improved by enhanced merge candidates, combined inter-intra prediction (CIIP), affine merge mode, sub-block temporal motion vector predictor (SbTMVP), merge mode with motion vector difference (MMVD), and geometric partition mode (GPM). In VVC, a decoder-side motion vector refinement (DMVR), bi-directional optical flow (BDOF), and prediction refinement with optical flow (PROF) are utilized to refine the motion vectors or the motion-compensated predictors at the decoder.

In ECM, several coding tools are developed to further improve the AMVP, Merge, and Skip modes such as bilateral matching AMVP-Merge mode, multi-hypothesis prediction (MHP), overlapped block motion compensation (OBMC), and the like. Furthermore, templating matching based decoder side motion vector refinement is also proposed to enhance the coding efficiency of the inter prediction.

Beyond the inter coding features in HEVC, VVC includes a number of refined inter prediction coding tools, such as extended merge prediction, MMVD, SMVD signaling, affine motion compensated prediction, SbTMVP, AMVR, motion field storage with 1/16^{th} luma sample MV storage and 8×8 motion field compression, bi-prediction with CU-level weight (BCW), BDOF, DMVR, GPM, CIIP, and the like.

After VVC is finalized, the ECM reference software is developed to study the potential need for standardization of future video coding technology. In the current ECM, several inter-prediction coding tools are included to provide further BD-rate savings, such as local illumination compensation (LIC), non-adjacent spatial candidate, template matching (TM), overlapped block motion compensation (OBMC), multi-hypothesis prediction (MHP), bilateral matching AMVP-Merge mode, and the like.

Details of some inter prediction methods specified in VVC and ECM will be described below.

### 1. Extended Merge Prediction

In VVC, a merge candidate list can be constructed by including five types of candidates in order: spatial MVP from spatial neighbor CUs, temporal MVP (TMVP) from collocated CUs, history-based MVP from a FIFO table, pairwise average MVP, and zero MVs.

A size of the merge list can be signaled in sequence parameter set header and a maximum allowed size of the merge list is 6. For each CU code in merge mode, an index of a best merge candidate is encoded using truncated unary binarization (TU). A first bin of the merge index is coded with context and bypass coding is used for other bins.

The derivation process of each category of merge candidates is provided in this session. As done in HEVC, VVC also supports parallel derivation of the merge candidate lists (or merging candidate lists) for all CUs within a certain size of area.

### 2. History-Based Merge Candidates Derivation

History-based MVP (HMVP) merge candidates are added to a merge list after spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-sub-block inter-coded CU, the associated motion information is added to the last entry of the table as a new HMVP candidate.

The HMVP table size S is set to be 6, which indicates up to 5 HMVP candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward, and the identical HMVP is inserted to the last entry of the table.

HMVP candidates can be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, some simplifications can be applied. For example, the last two entries in the table are redundancy checked to A1 and B1 spatial candidates, respectively. Once the total number of available merge candidates reaches the maximally allowed merge candidates minus 1, the merge candidate list construction process from HMVP is terminated.

### 3. Pair-Wise Average Merge Candidates Derivation

Pairwise average candidates are generated by averaging predefined pairs of candidates in the merge candidate list, using the first two merge candidates. The first merge candidate can be defined as p0Cand and the second merge candidate can be defined as p1Cand, respectively. The averaged motion vectors are calculated according to the availability of the motion vector of p0Cand and p1Cand separately for each reference list. If both motion vectors are available in one reference list, these two motion vectors are averaged even when they point to different reference pictures, and the reference picture is set to the one of p0Cand. If only one motion vector is available, the available one can be directly use. If no motion vector is available, the list is invalid. Also, if the half-pel interpolation filter indices of p0Cand and p1Cand are different, the pairwise average candidate is set to 0.

When the merge list is not full after pair-wise average merge candidates are added, the zero MVPs can be inserted at the end until the maximum merge candidate number is encountered.

4. Merge Mode with MVD (MMVD)

In addition to merge mode, where the implicitly derived motion information is directly used for prediction samples generation of a CU, MMVD is introduced in VVC. An MMVD flag is signaled right after a regular merge flag to specify whether MMVD mode is used for the CU.

In MMVD, after a merge candidate is selected, it is further refined by the signaled MVD information. The MVD information includes a merge candidate flag, an index to specify motion magnitude, and an index for indication of motion direction. In MMVD mode, one for the first two candidates in the merge list is selected to be used as MV basis. The MMVD candidate flag is signaled to specify which one is used between the first and second merge candidates. The motion magnitude is specified by a distance index which indicates a pre-defined offset from a starting point.

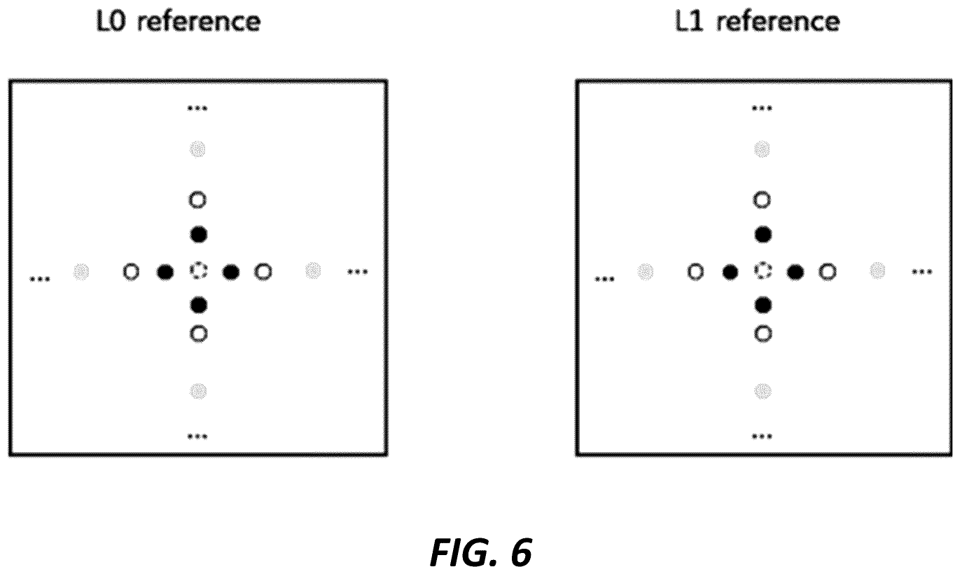

FIG. 6 shows MMVD search points of two references according to embodiments of the disclosure. The pre-defined offset is added to either horizontal component or vertical component of a starting MV. A relation of the distance index and the pre-defined offset is specified in Table 1.

TABLE 1
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 2. It's noted that the meaning of MVD sign can be variant according to the information of starting MVs. When the starting MVs is an un-prediction MV or bi-prediction MVs with both lists point to the same side of the current picture (i.e., picture order counts (POCs) of two references are both larger than the POC of the current picture, or are both smaller than the POC of the current picture), the sign in Table 2 specifies the sign of MV offset added to the starting MV. When the starting MVs is bi-prediction MVs with the two MVs point to the different sides of the current picture (i.e., the POC of one reference is larger than the POC of the current picture, and the POC of the other reference is smaller than the POC of the current picture), and the difference of POC in list 0 is greater than the one in list 1, the sign in Table 2 specifies the sign of MV offset added to the list0 MV component of starting MV and the sign for the list1 MV has opposite value. Otherwise, if the difference of POC in list 1 is greater than list 0, the sign in Table 2 specifies the sign of MV offset added to the list1 MV component of starting MV and the sign for the list0 MV has opposite value.

TABLE 2
Sign of MV offset specified by direction index

| | | | | |
|---|---|---|---|---|
| Direction IDX | 00 | 01 | 10 | 11 |
| x-axis | + | − | N/A | N/A |
| y-axis | N/A | N/A | + | − |

The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb. If the POC difference of L1 is greater than L0, the MVD for list 0 is scaled in the same way. If the starting MV is uni-predicted, the MVD is added to the available MV.

### 5. Affine Motion Compensated Prediction

In HEVC, only translation motion model is applied for motion compensation prediction (MCP). However, in some cases, there are non-translational motion types, e.g., zoom in/out, rotation, perspective motion, and other irregular motion. In VVC, affine prediction (e.g., affine merge mode, affine inter mode) can be used to compensate the non-translational motion.

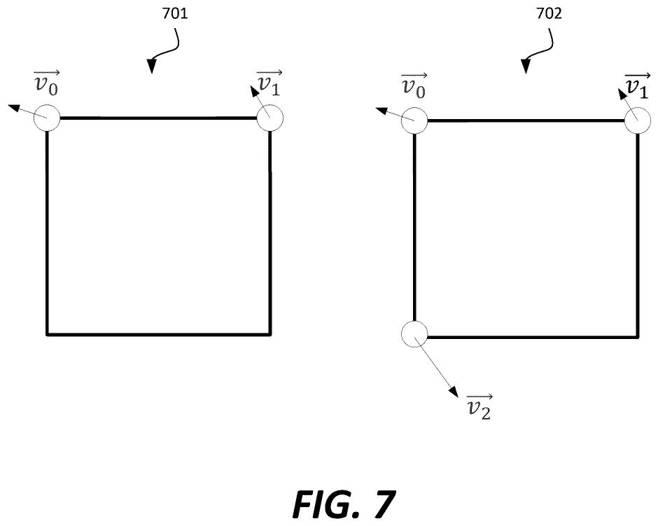

FIG. 7 shows exemplary 4-parameter and 6-parameter affine models 701 and 702 according to embodiments of the disclosure. In the 4-parameter affine model 701, there are two control point motion vectors (MVs) \vec{v₀} and \vec{v₁}, and motion vector at sample location (x, y) in a block is derived as

$$\{ \begin{matrix}{mv}_{x} = \frac{{mv}_{1 x} - {mv}_{0 x}}{W} x + \frac{{mv}_{0 y} - {mv}_{1 y}}{W} y + {mv}_{0 x} \\ {mv}_{y} = \frac{{mv}_{1 y} - {mv}_{0 y}}{W} x + \frac{{mv}_{1 x} - {mv}_{0 x}}{W} y + {mv}_{0 y}\end{matrix} \qquad ( Eq . 1 )$$

In the 6-parameter affine model 702, there are three control point MVs \vec{v₀}, \vec{v₁}, and \vec{v₂}, and motion vector at sample location (x, y) in a block is derived as

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} \qquad ( Eq . 2 )$$

In Eq. 1 and Eq. 2, (mv₀ₓ, mv_{0y}) is a motion vector of the top-left corner control point, (mv₁ₓ, mv_{1y}) is a motion vector of the top-right corner control point, and (mv₂ₓ, mv_{2y}) is a motion vector of the bottom-left corner control point.

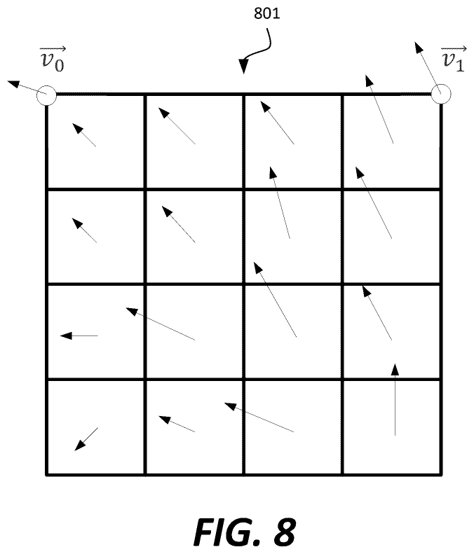

FIG. 8 shows an exemplary affine motion compensation for a 16×16 luma block 801 according to embodiments of the disclosure. In order to simplify the motion compensation prediction, block based affine transform prediction can be applied to the block 801 that includes sixteen 4×5 luma sub-blocks. To derive a motion vector of each 4×4 luma sub-block, the motion vector of the center sample of each sub-block, as shown in FIG. 8, can be calculated according to Eq. 1 and/or Eq. 2, and rounded to 1/16 fraction accuracy. Then, the motion compensation interpolation filters are applied to generate the prediction of each sub-block with the derived motion vector. The sub-block size of chroma components can also be set to be 4×4. The MV of a 4×4 chroma sub-block is calculated as an average of the MVs of the top-left and bottom-right luma sub-blocks in the collocated 8×8 luma region.

As done for translational motion inter prediction, there are also two affine motion inter prediction modes: affine merge mode and affine AMVP mode.

### 6. Affine Merge Prediction

Affine merge (AF_MERGE) mode can be applied to CUs with both width and height larger than or equal to 8. The control point motion vectors (CPMVs) of the current CU can be generated based on the motion information of the spatial neighboring CUs. There can be up to five CPMVP candidates and an index is signaled to indicate the one to be used for the current CU. The following three types of CPMV candidate are used to form the affine merge candidate list: (i) inherited affine merge candidates that extrapolated from the CPMVs of the neighboring CUs; (ii) constructed affine merge candidates CPMV predictors (CPMVPs) that are derived using the translational MVs of the neighboring CUs; and (iii) zero MVs.

In VVC, there are maximum two inherited affine candidates, which are derived from affine motion model of the neighboring blocks. One inherited affine candidate can be from left neighboring CUs and the other inherited affine candidate can be from above neighboring CUs.

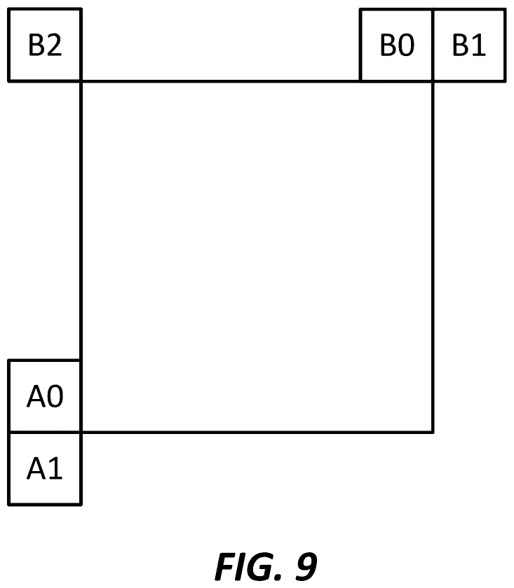

FIG. 9 shows candidate blocks of the inherited affine candidates according to embodiments of the disclosure. For the left predictor, the scan order is A0->A1, and for the above predictor, the scan order is B0->B1->B2. Only the first inherited candidate from each side is selected. No pruning check is performed between two inherited candidates. When a neighboring affine CU is identified, CPMVs of the neighboring affine CU are used to derived the CPMVP candidate in the affine merge list of the current CU.

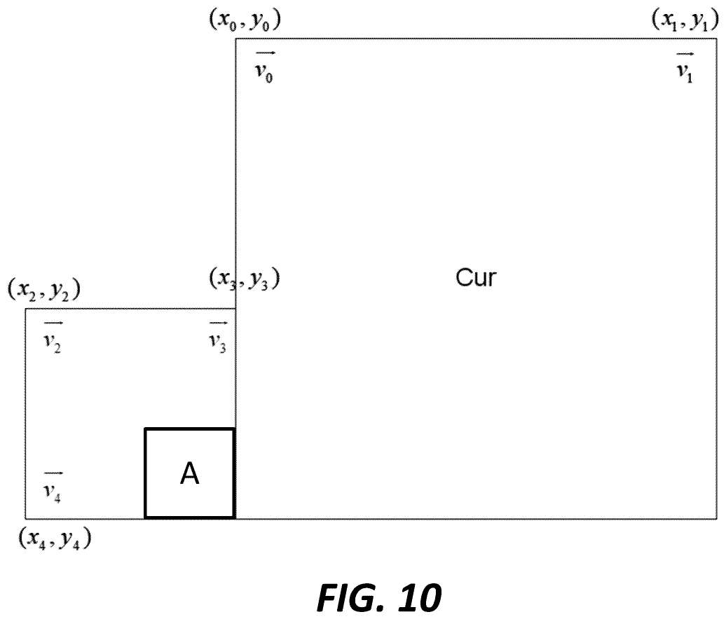

FIG. 10 shows an exemplary control point motion vector inheritance according to embodiments of the disclosure. If the neighboring left bottom block A is coded in affine mode, the motion vectors v₂, v₃, and v₄ of the top left corner, above right corner and left bottom corner of the CU which contains the block A are attained. When the block A is coded with 4-parameter affine model, the two CPMVs of the current CU are calculated according to v₂ and v₃. In case that the block A is coded with 6-parameter affine model, the three CPMVs of the current CU are calculated according to v₂, v₃, and v₄.

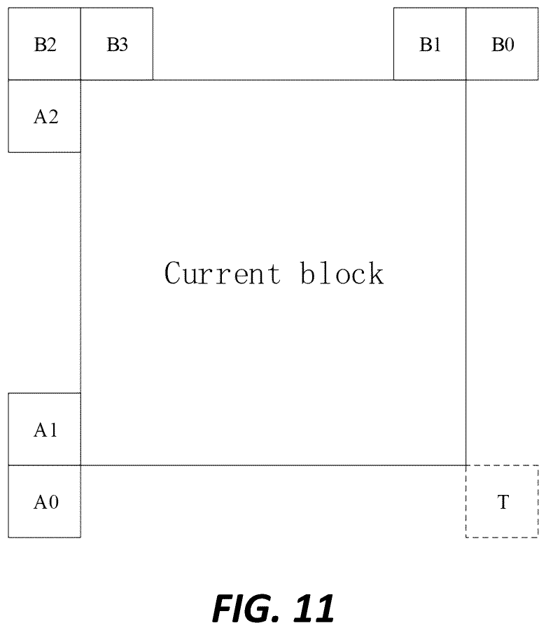

FIG. 11 shows example candidate positions for constructed affine merge mode according to embodiments of the disclosure. A constructed affine candidate is constructed by combining the neighbor translational motion information of each control point. The motion information for the control points can be derived from the specified spatial neighbors and temporal neighbors, as shown in FIG. 11. CPMVₖ (k=1, 2, 3, 4) represents the k-th control point. For CPMV₁, the B2->B3->A2 blocks are checked and the MV of the first available block is used. For CPMV₂, the B1->B0 blocks are checked. For CPMV₃, the A1->A0 blocks are checked. TMVP is used as CPMV₄ if it's available.

After MVs of four control points are attained, affine merge candidates are constructed based on the motion information of the MVs. The following combinations of control point MVs are used to construct in order: {CPMV₁, CPMV₂, CPMV₃}, {CPMV₁, CPMV₂, CPMV₄}, {CPMV₁, CPMV₃, CPMV₄}, {CPMV₂, CPMV₃, CPMV₄}, {CPMV₁, CPMV₂}, {CPMV₁, CPMV₃}.

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

After inherited affine merge candidates and constructed affine merge candidate are checked, if the list is still not full, zero MVs are inserted to the end of the list.

### 7. Decoder Side Motion Vector Refinement (DMVR)

In order to increase the accuracy of the MVs of the merge mode, a bilateral-matching (BM) based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1.

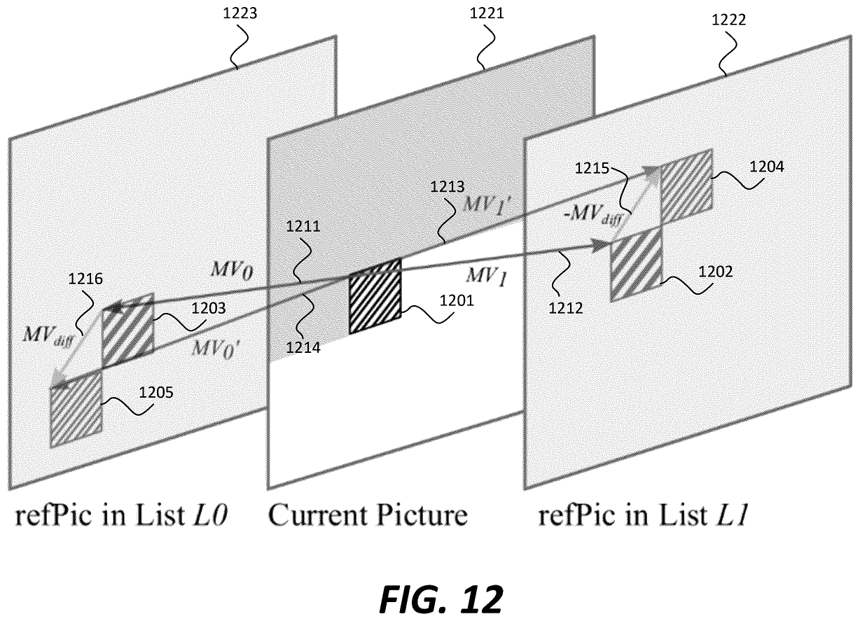

FIG. 12 shows an exemplary decoding side motion vector refinement according to embodiments of the disclosure. A sum of absolute differences (SAD) between the blocks 1204 and 1205 based on each MV candidate around the initial MV is calculated. The MV candidate with the lowest SAD becomes the refined MV and used to generate the bi-predicted signal.

In VVC, the application of DMVR is restricted and is only applied for the CUs which are coded with following modes and features: (i) CU level merge mode with bi-prediction MV; (ii) one reference picture is in the past and another reference picture is in the future with respect to the current picture; (iii) the distances (i.e., POC difference) from two reference pictures to the current picture are same; (iv) both reference pictures are short-term reference pictures; (v) CU has more than 64 luma samples; (vi) both CU height and CU width are larger than or equal to 8 luma samples; (vii) BCW weight index indicates equal weight; (viii) weighted prediction (WP is not enabled for the current block; (ix) CIIP mode is not used for the current block.

The refined MV derived by DMVR process is used to generate the inter prediction samples and also used in temporal motion vector prediction for future pictures coding. While the original MV is used in deblocking process and also used in spatial motion vector prediction for future CU coding.

### 8. Geometric Partitioning Mode (GPM)

In VVC, a geometric partitioning mode is supported for inter prediction. The geometric partitioning mode is signaled using a CU-level flag as one kind of merge mode, with other merge modes including the regular merge mode, the MMVD mode, the CIIP mode and the sub-block merge mode. In total 64 partitions are supported by geometric partitioning mode for each possible CU size w×h=2^{m}×2ⁿ with m, n∈{3 . . . 6} excluding 8×64 and 64×8.

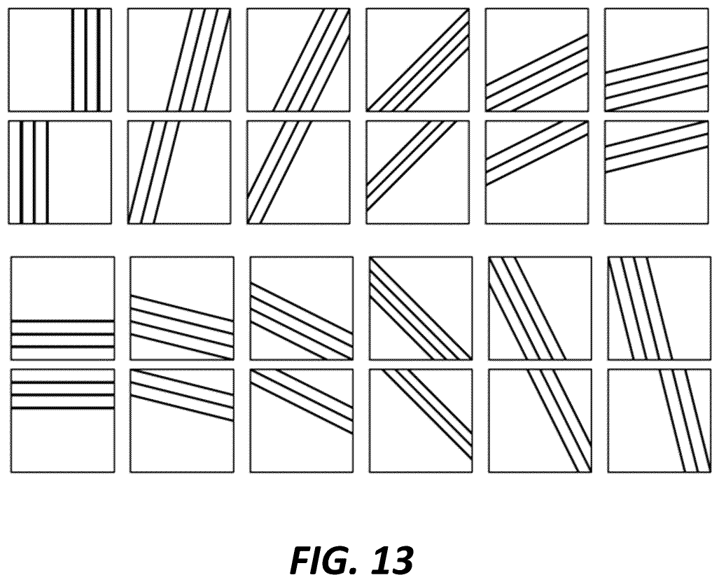

FIG. 13 shows examples of the GPM splits grouped by identical angles according to embodiments of the disclosure. When GPM is used, a CU is split into two parts by a geometrically located straight line, as shown in FIG. 13. A location of the splitting line is mathematically derived from the angle and offset parameters of a specific partition. Each part of a geometric partition in the CU is inter-predicted using its own motion. Only uni-prediction is allowed for each partition, that is, each part has one motion vector and one reference index. The uni-prediction motion constraint is applied to ensure that same as the conventional bi-prediction. Only two motion compensated prediction are needed for each CU.

If GPM is used for a current CU, then a geometric partition index indicating the partition mode of the geometric partition (angle and offset), and two merge indices (one for each partition) are further signaled. The number of maximum GPM candidate size is signaled explicitly in SPS and specifies syntax binarization for GPM merge indices. After predicting each of part of the geometric partition, the sample values along the geometric partition edge are adjusted using a blending processing with adaptive weights. This is the prediction signal for the whole CU and transform and quantization process will be applied to the whole CU as in other prediction modes. Finally, the motion field of a CU predicted using the geometric partition modes is stored.

### 9. Combined Inter and Intra Prediction (CIIP)

In VVC, when a CU is coded in merge mode, if the CU contains at least 64 luma samples (that is, CU width times CU height is equal to or larger than 64), and if both CU width and CU height are less than 128 luma samples, an additional flag is signaled to indicate if the combined inter/intra prediction (CIIP) mode is applied to the current CU. The CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using a weighted averaging.

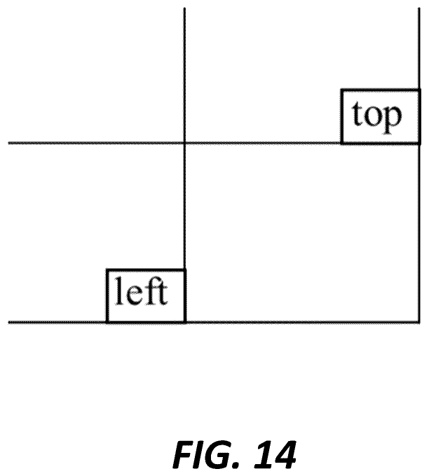

FIG. 14 shows top and left neighboring blocks used in CIIP weight derivation according to embodiments of the disclosure. The weight value in CIIP is calculated depending on the coding modes of the top and left neighboring blocks (depicted in FIG. 14) as follows: if the top neighbor is available and intra coded, then set isIntraTop to 1, otherwise set isIntraTop to 0; if the left neighbor is available and intra coded, then set isIntraLeft to 1, otherwise set isIntraLeft to 0; if (isIntraLeft+isIntraTop) is equal to 2, then wt is set to 3; Otherwise, if (isIntraLeft+isIntraTop) is equal to 1, then wt is set to 2; Otherwise, set wt to 1. The CIIP prediction is formed as follows:

$${P}_{CIIP} = ( ( 4 - wt ) * {P}_{inter} + wt * {P}_{intra} + 2 ) ≫ 2 \qquad ( Eq . 3 )$$

### 10. Template Matching (TM)

Template matching (TM) is a decoder-side MV derivation method to refine the motion information of the current CU by finding the closest match between a template (i.e., top and/or left neighboring blocks of the current CU) in the current picture and a block (i.e., same size to the template) in a reference picture.

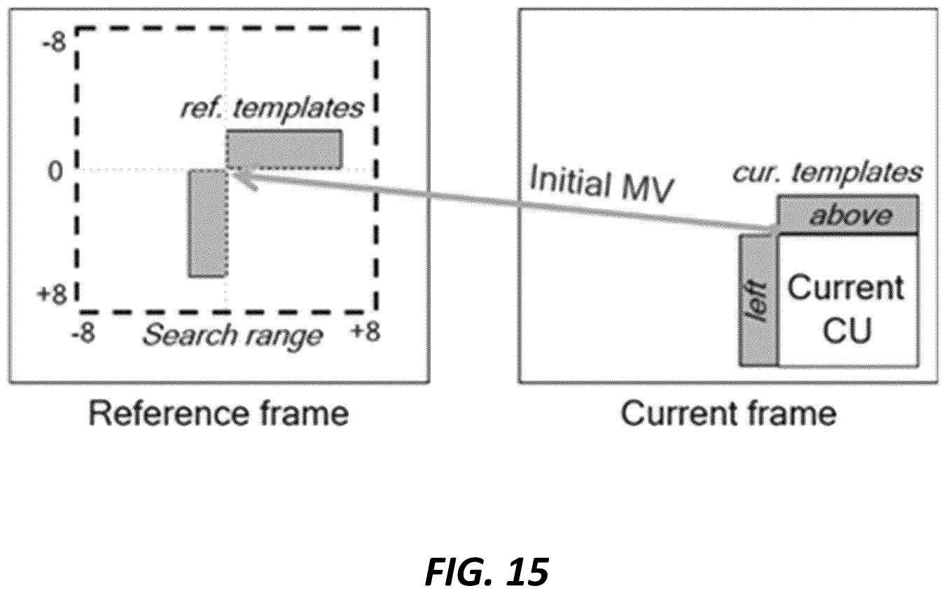

FIG. 15 shows examples of template matching according to embodiments of the disclosure. As shown in FIG. 15, a better MV is searched around the initial motion of the current CU within a [−8, +8]-pel search range. The template matching method in JVET-J0021 is used with the following modifications: search step size is determined based on AMVR mode and TM can be cascaded with bilateral matching process in merge modes.

In AMVP mode, an MVP candidate is determined based on template matching error to select the one which reaches the minimum difference between the current block template and the reference block template, and then TM is performed only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 3. This search process ensures that the MVP candidate still keeps the same MV precision as indicated by the AMVR mode after TM process. In the search process, if the difference between the previous minimum cost and the current minimum cost in the iteration is less than a threshold that is equal to the area of the block, the search process terminates.

TABLE 3
Search patterns of AMVR and merge mode with AMVR

| | AMVR mode | | | | Merge mode | |
|---|---|---|---|---|---|---|
| Search | 4- | Full- | Half- | Quarter- | AltIF = | AltIF = |
| pattern | pel | pel | pel | pel | 0 | 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| 1/8-pel cross | | | | | v | |

In merge mode, similar search method is applied to the merge candidate indicated by the merge index. As Table 3 shows, TM may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and sub-block-based bilateral matching (BM) methods, depending on whether BM can be enabled or not according to its enabling condition check.

### 11. Multi-Pass Decoder-Side Motion Vector Refinement

A multi-pass decoder-side motion vector refinement is applied. In the first pass, bilateral matching (BM) is applied to the coding block. In the second pass, BM is applied to each 16×16 sub-block within the coding block. In the third pass, MV in each 8×8 sub-block is refined by applying bi-directional optical flow (BDOF). The refined MVs are stored for both spatial and temporal motion vector prediction.

In the first pass, a refined MV is derived by applying BM to a coding block. Similar to DMVR, in bi-prediction operation, a refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.

BM performs a local search to derive integer sample precision intDeltaMV. The local search applies a 3×3 square search pattern to loop through the search range [−sHor, sHor] in horizontal direction and [−sVer, sVer] in vertical direction, wherein, the values of sHor and sVer are determined by the block dimension, and the maximum value of sHor and sVer is 8.

The BM cost is calculated as: bilCost=mvDistanceCost+sadCost. When the block size cbW×cbH is greater than 64, mean removed SAD (MRSAD) cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and continue to search for the minimum cost, until it reaches the end of the search range.

The fractional sample refinement is further applied to derive the final deltaMV. The refined MVs after the first pass is then derived as MV0_pass1=MV0+deltaMV and MV1_pass1=MV1−deltaMV.

In the second pass, a refined MV is derived by applying BM to a 16×16 grid sub-block. For each sub-block, a refined MV is searched around the two MVs (MV0_pass1 and MV1_pass1), obtained on the first pass, in the reference picture list L0 and L1. The refined MVs (MV0_pass2(sbIdx2) and MV1_pass2(sbIdx2)) are derived based on the minimum bilateral matching cost between the two reference sub-blocks in L0 and L1.

For each sub-block, BM performs a full search to derive integer sample precision intDeltaMV. The full search has a search range [−sHor, sHor] in horizontal direction and [−sVer, sVer] in vertical direction, where the values of sHor and sVer are determined by the block dimension, and the maximum value of sHor and s Ver is 8.

The BM cost is calculated by applying a cost factor to the sum of absolute transformed difference (SATD) cost between two reference sub-blocks, as: bilCost=satdCost×costFactor.

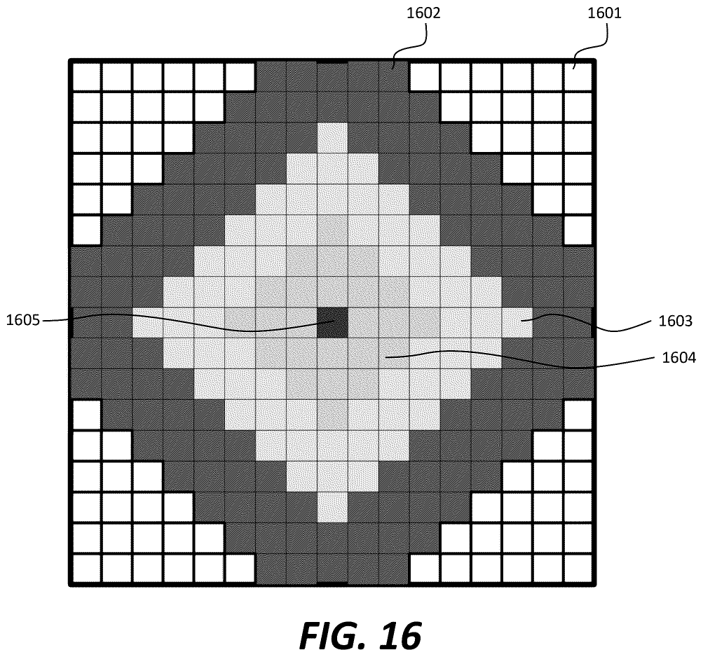

FIG. 16 shows exemplary diamond shape search regions according to embodiments of the disclosure. The search area (2×sHor+1)×(2×sVer+1) is divided up to 5 diamond shape search regions 1601-1605, as shown in FIG. 16. Each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbWxsbH, the int-pel full search is terminated. Otherwise, the int-pel full search continues to the next search region until all search points are examined. Additionally, if the difference between the previous minimum cost and the current minimum cost in the iteration is less than a threshold that is equal to the area of the block, the search process terminates.

The VVC DMVR fractional sample refinement is further applied to derive the final deltaMV (sbIdx2). The refined MVs at second pass is then derived as MV0_pass2(sbIdx2)=MV0_pass1+deltaMV(sbIdx2) and MV1_pass2(sbIdx2)=MV1_pass1−deltaMV(sbIdx2).

In the third pass, a refined MV is derived by applying BDOF to an 8×8 grid sub-block. For each 8×8 sub-block, BDOF refinement is applied to derive scaled Vx and Vy without clipping starting from the refined MV of the parent sub-block of the second pass. The derived bioMv(Vx, Vy) is rounded to 1/16 sample precision and clipped between −32 and 32. The refined MVs (MV0_pass3(sbIdx3) and MV1_pass3(sbIdx3)) at third pass are derived as MV0_pass3(sbIdx3)=MV0_pass2(sbIdx2)+bioMv and MV1_pass3(sbIdx3)=MV0_pass2(sbIdx2)−bioMv.

### 12. Bilateral Matching AMVP-Merge Mode

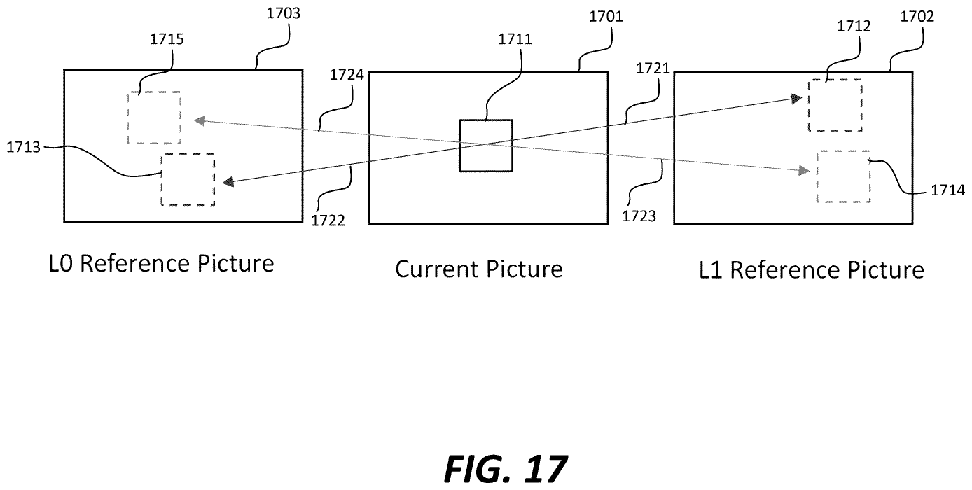

FIG. 17 shows an exemplary bilateral matching AMVP-merge mode according to embodiments of the disclosure. As shown in FIG. 17, a bi-directional predictor in the bilateral matching AMVP-merge mode can include an AMVP predictor in one direction Lx (x can be 0 or 1) and a merge predictor in the other direction (1−Lx). The bilateral matching AMVP-merge mode can be enabled to a coding block 1711 when the merge predictor and the AMVP predictor satisfy DMVR condition, where there is at least one reference picture (one of reference pictures 1702 and 1703) from the past, one reference picture (the other one of the reference pictures 1702 and 1703) from the future relatively to the current picture, and distances from the two reference pictures to the current picture are the same. The bilateral matching MV refinement is applied to MVs of the merge predictor and AMVP predictor as a starting point. If template matching is enabled, template matching MV refinement is applied to one of the merge predictor or the AMVP predictor, which has a higher template matching cost.

The AMVP predictor of the bilateral matching AMVP-merge mode can be signaled as a regular uni-directional AMVP predictor. For example, a reference index and an MVD of the AMVP predictor are signaled. An MVP index of the AMVP predictor can be derived when template matching is used or be signaled when template matching is disabled.

The merge predictor of the bilateral matching AMVP-merge mode can be implicitly derived by minimizing the BM cost between the AMVP predictor and the merge candidate, i.e., for a pair of the AMVP and merge candidate MVs. For every merge candidate in the merge candidate list which has the other direction (1-Lx) MVs, the BM cost is calculated using the respective merge candidate MV and the AMVP MV. The merge candidate with the lowest BM cost is selected. The BM refinement can be applied to the coding block 1711 with the selected merge candidate MV and the AMVP MV as a starting point.

The third pass of multi-pass DMVR, which is 8×8 sub-PU BDOF refinement of the multi-pass DMVR, can be enabled to the coding block 1711 in the bilateral matching AMVP-merge mode.

The bilateral matching AMVP-merge mode can be indicated by a first flag. If the bilateral matching AMVP-merge mode is enabled, the AMVP direction Lx can be further indicated by a second flag.

When the bilateral matching AMVP-merge mode is used for a coding block and the template matching is enabled, MVD is not signaled. An additional pair of AMVP-merge MVPs is introduced. The merge candidate list is sorted based on the BM cost in an increase order. An index (0 or 1) is signaled to indicate which merge candidate in the sorted merge candidate list to be used. When there is only one candidate in the merge candidate list, the pair of AMVP MVP and merge MVP without the bilateral matching MV refinement can be padded.

### VI. Improved Bilateral Matching AMVP-Merge Mode

As described above, the bilateral matching AMVP-merge mode can be performed based on the following order: (i) constructing an AMVP predictor; (ii) constructing a merge predictor; (iii) performing MV refinement; and (iv) performing motion compensation (MC).

For the AMVP predictor, if template matching (TM) process is enabled, the AMVP candidate list can be reordered based on TM cost, and the first one in the AMVP candidate list can be selected as the AMVP predictor in the bilateral matching AMVP-merge mode.

For the merge predictor, the merge candidate list can be set as a uni-directional predictor. The BM cost can be calculated using the merge candidate MVs and the AMVP MV. One of the merge candidates can be selected as the merge predictor, based on a signaled index (0 or 1).

For the MV refinement, if the merge predictor and the AMVP predictor satisfy DMVR condition, bilateral matching MV refinement can be applied to the merge candidate predictor and AMVP predictor as a starting point, and CU level bilateral matching MV refinement (e.g., first pass of MP-DMVR) can be applied. Otherwise, if TM is enabled, template matching MV refinement can be applied to one of the merge predictor or the AMVP predictor, which has a higher TM cost.

After the MV refinement, MVD can be added, and third pass of multi-pass DMVR, which is 8×8 sub-PU BDOF refinement of the multi-pass DMVR, can be applied.

It can be seen that, if the TM process is enabled, the TM process is applied twice in the bilateral matching AMVP-merge mode. A first TM process is applied on generating the AMVP predictor, and a second TM process is applied on comparing the TM costs between the AMVP predictor and merge predictor during the MV refinement, indicating more reference samples are needed for the two TM processes and thus resulting in a bandwidth increase.

This disclosure provides embodiments to reduce the complexity of the bilateral matching AMVP-merge mode.

In an embodiment, during the MV refinement, the TM process is set to be applied to the merge predictor. Accordingly, the TM cost calculation used to compare the costs between the AMVP predictor and merge predictor can be omitted.

In an embodiment, during the MV refinement, the TM process is set to be applied to the AMVP predictor. Accordingly, the TM cost calculation used to compare the costs between the AMVP predictor and merge predictor can be omitted.

In an embodiment, when MVD is signaled for the AMVP predictor and the MVD is not zero, the TM process is set to be applied to the AMVP predictor during the MV refinement; otherwise, when the MVD is zero, the TM process is set to be applied to the merge predictor during the MV refinement.

In an embodiment, after the bilateral matching MV refinement is done for the AMVP-merge mode, the AMVP predictor and merge predictor are selectively to use either the refined MVs or the original MVs before the refinement. In an example, only the AMVP predictor uses the refined MV. In an example, only the merge predictor uses the refined MV.

In an embodiment, the merge modes used to generate the merge predictor include but are not limited to affine merge, CIIP, MMVD, GPM, and the like.

In an embodiment, the AMVP modes used to generate the AMVP predictor include but are not limited affine mode.

### VII. Decoding Flowchart

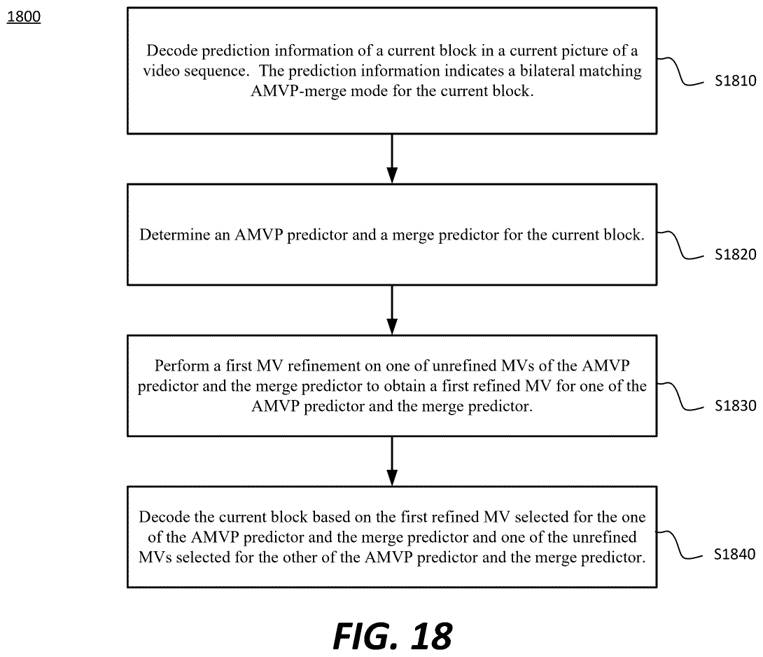

FIG. 18 shows a flow chart outlining a decoding process 1800 according to an embodiment of the disclosure. The decoding process 1800 can be used in the reconstruction of a block coded in an LIC mode, so to generate a prediction block for the block under reconstruction. In various embodiments, the decoding process 1800 can be executed by processing circuitry, such as CPU 341 and/or GPU 342 of the computer system 300. In some embodiments, the decoding process 1800 is implemented in software instructions, thus when the processing circuitry executes the software instructions, the processing circuitry performs the decoding process 1800. The decoding process can start at S1810.

At step S1810, the process 1800 decodes prediction information of a current block in a current picture of a video sequence. The prediction information indicates a bilateral matching AMVP-merge mode for the current block. Then, the process 1800 proceeds to step S1820.

At step S1820, the process 1800 determines an AMVP predictor and a merge predictor for the current block. Then, the process 1800 proceeds to step S1830.

At step S1830, the process 1800 performs a first MV refinement on one of unrefined MVs of the AMVP predictor and the merge predictor to obtain a first refined MV for one of the AMVP predictor and the merge predictor. Then, the process 1800 proceeds to step S1840.

At step S1840, the process 1800 decodes the current block based on the first refined MV selected for the one of the AMVP predictor and the merge predictor and one of the unrefined MVs selected for the other of the AMVP predictor and the merge predictor. Then, the process 1800 terminates.

In an embodiment, the process 1800 performs a second MV refinement on the other of the AMVP predictor and the merge predictor to obtain a second refined MV for the other of the AMVP predictor and the merge predictor.

In an embodiment, the first MV refinement is one of bilateral matching refinement and template matching refinement.

In an embodiment, the prediction information indicates an MVD, and the process 1800 performs the first MV refinement on the one of the unrefined MVs of the AMVP predictor and the merge predictor based on a value of the MVD.

In an embodiment, the process 1800 performs the first MV refinement on the unrefined MV of the AMVP predictor in response to the value of the MVD not being zero. The process 1800 performs the first MV refinement on the unrefined MV of the merge predictor in response to the value of the MVD being zero.

In an embodiment, the merge mode used in the bilateral matching AMVP-merge mode is one of affine merge, CIIP, MMVD, intra block copy (IBC) merge, and GPM.

In an embodiment, the AMVP mode used in the bilateral matching AMVP-merge mode is one of affine mode and IBC mode.

### VIII. Encoding Flowchart

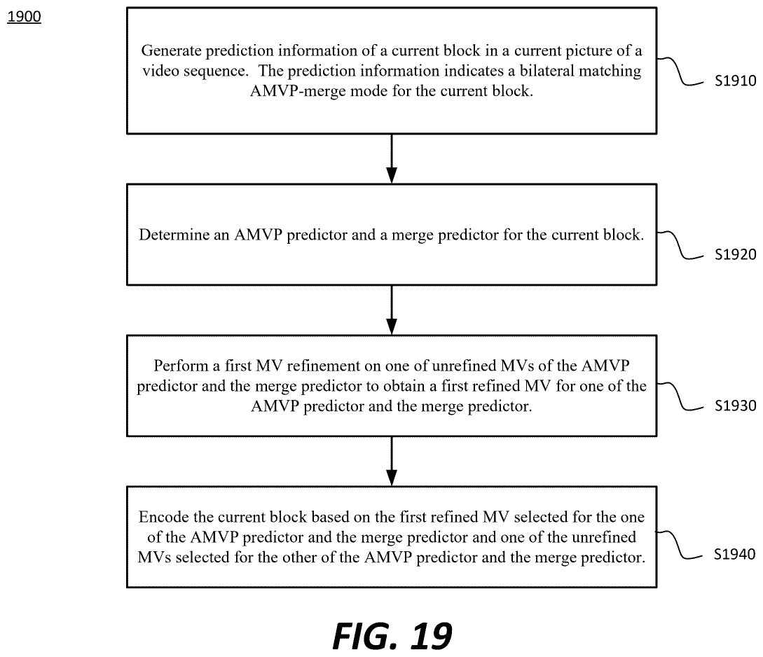

FIG. 19 shows a flow chart outlining an encoding process 1900 according to an embodiment of the disclosure. The encoding process 1900 can be used in encoding a to-be-encoded block using an LIC mode. In various embodiments, the encoding process 1900 can be executed by processing circuitry, such as CPU 341 and/or GPU 342 of the computer system 300. In some embodiments, the encoding process 1900 is implemented in software instructions, thus when the processing circuitry executes the software instructions, the processing circuitry performs the encoding process 1900. The encoding process can start at S1910.

At step S1910, the process 1900 generates prediction information of a current block in a current picture of a video sequence. The prediction information indicates a bilateral matching AMVP-merge mode for the current block. Then, the process proceeds to step S1920.

At step S1920, the process 1900 determines an AMVP predictor and a merge predictor for the current block. Then, the process 1900 proceeds to step S1930.

At step S1930, the process 1900 performing a first MV refinement on one of unrefined MVs of the AMVP predictor and the merge predictor to obtain a first refined MV for one of the AMVP predictor and the merge predictor. Then, the process 1900 proceeds to step S1940.

At step S1940, the process 1900 encodes the current block based on the first refined MV selected for the one of the AMVP predictor and the merge predictor and one of the unrefined MVs selected for the other of the AMVP predictor and the merge predictor. Then, the process 1900 terminates.

In an embodiment, the process 1900 performs a second MV refinement on the other of the AMVP predictor and the merge predictor to obtain a second refined MV for the other of the AMVP predictor and the merge predictor.

In an embodiment, the first MV refinement is one of bilateral matching refinement and template matching refinement.

In an embodiment, the prediction information indicates an MVD, and the process 1900 performs the first MV refinement on the one of the unrefined MVs of the AMVP predictor and the merge predictor based on a value of the MVD.

In an embodiment, the process 1900 performs the first MV refinement on the unrefined MV of the AMVP predictor in response to the value of the MVD not being zero. The process 1900 performs the first MV refinement on the unrefined MV of the merge predictor in response to the value of the MVD being zero.

In an embodiment, the merge mode used in the bilateral matching AMVP-merge mode is one of affine merge, CIIP, MMVD, IBC merge, and GPM.

In an embodiment, the AMVP mode used in the bilateral matching AMVP-merge mode is one of affine mode and IBC mode.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method of video decoding at a decoder, comprising:
decoding prediction information of a current block in a current picture of a video sequence, the prediction information indicating a bilateral matching advanced motion vector prediction (AMVP)-merge mode for the current block;
determining an AMVP predictor and a merge predictor for the current block;
performing a first motion vector (MV) refinement on one of unrefined MVs of the AMVP predictor and the merge predictor to obtain a first refined MV for one of the AMVP predictor and the merge predictor; and
decoding the current block based on the first refined MV selected for the one of the AMVP predictor and the merge predictor and one of the unrefined MVs selected for the other of the AMVP predictor and the merge predictor.

2. The method of claim 1, further comprising:
performing a second MV refinement on the other of the AMVP predictor and the merge predictor to obtain a second refined MV for the other of the AMVP predictor and the merge predictor.

3. The method of claim 1, wherein the first MV refinement is one of bilateral matching refinement and template matching refinement.

4. The method of claim 1, wherein the prediction information indicates a MV difference (MVD), and the performing includes:
performing the first MV refinement on the one of the unrefined MVs of the AMVP predictor and the merge predictor based on a value of the MVD.

5. The method of claim 4, wherein the performing includes:
performing the first MV refinement on the unrefined MV of the AMVP predictor in response to the value of the MVD not being zero; and
performing the first MV refinement on the unrefined MV of the merge predictor in response to the value of the MVD being zero.

6. The method of claim 1, wherein the merge mode used in the bilateral matching AMVP-merge mode is one of affine merge, combined inter-intra prediction (CIIP), merge mode with motion vector difference (MMVD), intra block copy (IBC) merge, and geometric partition mode (GPM).

7. The method of claim 1, wherein the AMVP mode used in the bilateral matching AMVP-merge mode is one of affine mode, and intra block copy (IBC) merge mode.

8. An apparatus for video decoding, comprising:
processing circuitry configured to
decode prediction information of a current block in a current picture of a video sequence, the prediction information indicating a bilateral matching advanced motion vector prediction (AMVP)-merge mode for the current block;
determine an AMVP predictor and a merge predictor for the current block;
perform a first motion vector (MV) refinement on one of unrefined MVs of the AMVP predictor and the merge predictor to obtain a first refined MV for one of the AMVP predictor and the merge predictor; and
decode the current block based on the first refined MV selected for the one of the AMVP predictor and the merge predictor and one of the unrefined MVs selected for the other of the AMVP predictor and the merge predictor.

9. The apparatus of claim 8, wherein the processing circuitry is configured to:
perform a second MV refinement on the other of the AMVP predictor and the merge predictor to obtain a second refined MV for the other of the AMVP predictor and the merge predictor.

10. The apparatus of claim 8, wherein the first MV refinement is one of bilateral matching refinement and template matching refinement.

11. The apparatus of claim 8, wherein the prediction information indicates a MV difference (MVD), and the processing circuitry is configured to:
perform the first MV refinement on the one of the unrefined MVs of the AMVP predictor and the merge predictor based on a value of the MVD.

12. The apparatus of claim 11, wherein the processing circuitry is configured to:
perform the first MV refinement on the unrefined MV of the AMVP predictor in response to the value of the MVD not being zero; and
perform the first MV refinement on the unrefined MV of the merge predictor in response to the value of the MVD being zero.

13. The apparatus of claim 8, wherein the merge mode used in the bilateral matching AMVP-merge mode is one of affine merge, combined inter-intra prediction (CIIP), merge mode with motion vector difference (MMVD), intra block copy (IBC) merge, and geometric partition mode (GPM).

14. The apparatus of claim 8, wherein the AMVP mode used in the bilateral matching AMVP-merge mode is one of affine mode, and intra block copy (IBC) mode.

15. A method of video encoding at an encoder, comprising:
generating prediction information of a current block in a current picture of a video sequence, the prediction information indicating a bilateral matching advanced motion vector prediction (AMVP)-merge mode for the current block;
determining an AMVP predictor and a merge predictor for the current block;
performing a first motion vector (MV) refinement on one of unrefined MVs of the AMVP predictor and the merge predictor to obtain a first refined MV for one of the AMVP predictor and the merge predictor; and
encoding the current block based on the first refined MV selected for the one of the AMVP predictor and the merge predictor and one of the unrefined MVs selected for the other of the AMVP predictor and the merge predictor.

16. The method of claim 15, further comprising:
performing a second MV refinement on the other of the AMVP predictor and the merge predictor to obtain a second refined MV for the other of the AMVP predictor and the merge predictor.

17. The method of claim 15, wherein the first MV refinement is one of bilateral matching refinement and template matching refinement.

18. The method of claim 15, wherein the prediction information indicates a MV difference (MVD), and the performing includes:
performing the first MV refinement on the one of the unrefined MVs of the AMVP predictor and the merge predictor based on a value of the MVD.

19. The method of claim 18, wherein the performing includes:
performing the first MV refinement on the unrefined MV of the AMVP predictor in response to the value of the MVD not being zero; and
performing the first MV refinement on the unrefined MV of the merge predictor in response to the value of the MVD being zero.

20. The method of claim 15, wherein the merge mode used in the bilateral matching AMVP-merge mode is one of affine merge, combined inter-intra prediction (CIIP), merge mode with motion vector difference (MMVD), intra block copy (IBC) merge, and geometric partition mode (GPM).

21. The apparatus of claim 15, wherein the AMVP mode used in the bilateral matching AMVP-merge mode is one of affine mode, and intra block copy (IBC) mode.
